(19) United States
(12) Patent Application Publication
(10) Pub. No.: US 2024/0273011 A1
(43) Pub. Date: Aug. 15, 2024

(54) SYSTEM AND METHOD FOR REFACTORING SOFTWARE AND SOFTWARE ARCHITECTURE

(71) Applicant: Architecture Technology Corporation, Minneapolis, MN (US)

(72) Inventors: Colleen Kimball, Ithaca, NY (US); Jason Hogan, Ithaca, NY (US); Ryan DeBolt, Charlotte, NC (US); Martiros Shakhzadyan, McLean, VA (US)

(21) Appl. No.: 18/169,028

(22) Filed: Feb. 14, 2023

(51) Int. Cl. G06F 11/36

(52) U.S. Cl. CPC G06F 11/3688

(57) ABSTRACT

This disclosure describes a profiling system comprising a memory, the memory storing instructions for profiling an application under test (AUT), and one or more processors communicatively coupled to the memory. The processors are configured to execute the instructions. The instructions when executed cause the one or more processors to initiate, within the one or more processors, a launcher for profiling an aspect of the AUT, transfer, to the AUT, one or more profiling tests and one or more profiler modules associated with the one or more profiling tests, start the one or more profiling tests in the AUT under launcher control, including setting up profiling during initialization of a process in the AUT, receive, at the profiling system, data collected for each profiling test, and determine one or more test scores for the aspect of the AUT based on the data collected for each profiling test.

### TECHNICAL FIELD

This disclosure generally relates to software application profiling and refactoring

### BACKGROUND

Application profilers are used to measure the time required to execute sections of software. Profilers are also used to monitor and evaluate the amount of memory used, time for input/output operations, etc. Application profilers exist for many programming languages. In addition, software developers can manually profile their application by inserting their own profiling instructions into the software.

Many existing application profilers require significant interaction with the developer to exercise the software. This makes profiling applications tedious and error prone. For example, between invoking the profiler, a developer may make small changes to the application configuration, unknowingly impacting the performance of the application and leading to inconsistent results.

Many existing application profilers also collect data for the entire application, resulting in large amounts of data that must be processed to display the results. Also, by monitoring the entire application, profiler applications may impact the behavior of the application under test, slowing down the process even further. Furthermore, existing application profilers are primarily concerned with data collection, and do very little to assist in the analysis of the collected data.

### SUMMARY

In general, this disclosure describes an application performance and memory usage profiler for legacy applications. In one example approach, the profiler automatically runs the application under test (AUT) and records performance and memory data as the user interacts with the application. In one example, the profiler supports applications written in managed, .NET languages as well as in native C++ applications.

In one example approach, the profiler compares performance and memory data from multiple profiling executions to identify methods whose performance has changed the most, to identify performance bottlenecks based on user-specified input, and to identify peaks in memory use. The analytical capabilities employed by the profiler may also be used to predict performance bottlenecks, and to identify potential application scalability issues.

In one example, this disclosure describes a profiling system comprising a memory, the memory storing instructions for profiling an AUT, and one or more processors communicatively coupled to the memory. The processors are configured to execute the instructions. The instructions when executed cause the one or more processors to initiate, within the one or more processors, a launcher for profiling an aspect of the AUT, transfer, to the AUT, one or more profiling tests and one or more profiler modules associated with the one or more profiling tests, start the one or more profiling tests in the AUT under launcher control, including setting up profiling during initialization of a process in the AUT, receive, at the profiling system, data collected for each profiling test, and determine one or more test scores for the aspect of the AUT based on the data collected for each profiling test.

In another example, this disclosure describes a method comprising initiating, within one or more processors, a launcher for profiling an aspect of the AUT, transferring, to the AUT, one or more profiling tests and one or more profiler modules associated with the one or more profiling tests, starting the one or more profiling tests in the AUT under launcher control, including setting up profiling during initialization of a process in the AUT, receiving, at the profiling system, data collected for each profiling test, and determining one or more test scores for the aspect of the AUT based on the data collected for each profiling test.

In another example, this disclosure describes a non-transitory computer-readable storage medium storing instructions that, when executed, cause one or more processors of a profiling system to initiate, within the one or more processors, a launcher for profiling an aspect of the AUT, transfer, to the AUT, one or more profiling tests and one or more profiler modules associated with the one or more profiling tests, start the one or more profiling tests in the AUT under launcher control, including setting up profiling during initialization of a process in the AUT, receive, at the profiling system, data collected for each profiling test, and determine one or more test scores for the aspect of the AUT based on the data collected for each profiling test.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example application performance and memory usage profiling system 100 analyzing an application under test (AUT), in accordance with the techniques of the disclosure.

FIG. 2 is a flowchart showing an example method of testing an application under test, in accordance with the techniques of the disclosure.

FIGS. 3A-3D illustrate examples of automated profiling, in accordance with the techniques of the disclosure.

FIG. 4 illustrates an example profiler command line, in accordance with the techniques of the disclosure.

FIG. 5 illustrates an example of component level profiling, in accordance with the techniques of the disclosure.

FIGS. 6A and 6B illustrate examples of complexity timing analysis, in accordance with aspects of the present disclosure.

FIG. 7 illustrates an example of sharing tests within profiling system 100, in accordance with aspects of the disclosure.

FIG. 8 illustrates an example profiler system installed on a computing platform, in accordance with the techniques of the disclosure.

Like reference characters refer to like elements throughout the figures and description.

### DETAILED DESCRIPTION

In the software development process, it is advantageous to catch poor performance and excessive memory consumption prior to the deployment of software. If software is released with these problems, it is likely that users of the software will experience lengthy delays and even software crashes. For most software users, this is a nuisance that may discourage further use of the software; however, in very time-sensitive situations, such as Department of Defense (DoD) software, a delay or crash may cause massive problems for the users and may be very dangerous when software is being used in the field. Unfortunately, performance and memory problems are not always easy to catch when testing software. If the software is tested with relatively small amounts of data, then it can be difficult to notice performance problems. Testing with large amounts of data can also be difficult because it may take a long time for the test to complete, and it can be difficult to tell what is causing the delay.

Traditional profilers address some of these issues but there are a few limitations that make investigating performance and memory problems difficult. Most performance profilers collect timing information for all functions in the application under test (AUT). While this method of profiling can sometimes be useful, it is more common that developers will be interested in the performance data for only a few specific functions. Another problem with traditional methods of profiling is that they may severely slow the AUT as the test is being run since the profiler is busy collecting information about each method. Additionally, when the test is complete, the user is presented with a large amount of profiling data. It may be difficult and time-consuming to view such quantities of data, making it more difficult to find the data to be investigated.

Another limitation of traditional profilers is that they are unable to catch performance issues with small input sizes, requiring very large test data sets that take a long time to complete. Many also do not provide an automated profiling option, so a user has to take the time to manually perform these large tests.

The techniques described herein address these challenges. In one example approach, an application performance and memory usage profiler profiles applications. In one such example approach, a software developer creates a test configuration in the profiler and configures a test by selecting to profile performance (e.g., processor utilization), memory, or both, as well as by selecting which code functions and/or methods to focus on when profiling the AUT. While the test is running, the user interacts with the application to invoke the method(s) that were selected for targeted profiling. Alternatively, the profiler may be configured to automatically invoke the method(s) being targeted. In some example approaches, the profiler includes automated performance testing that programmatically sets input parameters for a method, allowing for the collection of various data without user interaction.

In one example approach, the profiler records performance data only for the methods that were selected when the test was created. When the test is finished running, the profiler automatically parses and analyzes the data, generating visualizations of the tests results, including graphs, charts, and the like. Multiple runs can be performed for the same test configuration, allowing developers to address performance and memory problems within their code and then re-test a new build of the code to see how the performance and memory use has improved.

Alternatively, developers may choose to exercise the same test configuration with different input parameters and/or data sets for each run, allowing them to see how performance and memory use may change based on use case.

Regardless of analysis objective, the profiler provides developers with tools to gain additional insights from data retrieved during performance testing. In addition to comparing two tests—or two runs within a test—and computing their differences in, for instance, processor performance or in memory use, in some example approaches, the profiler conducts complexity timing analysis over multiple datasets. Such analysis results may, in turn, be used by developers to predict the performance of the AUT and/or of individual targeted methods and to assess how performance scales with data set size and/or characteristics.

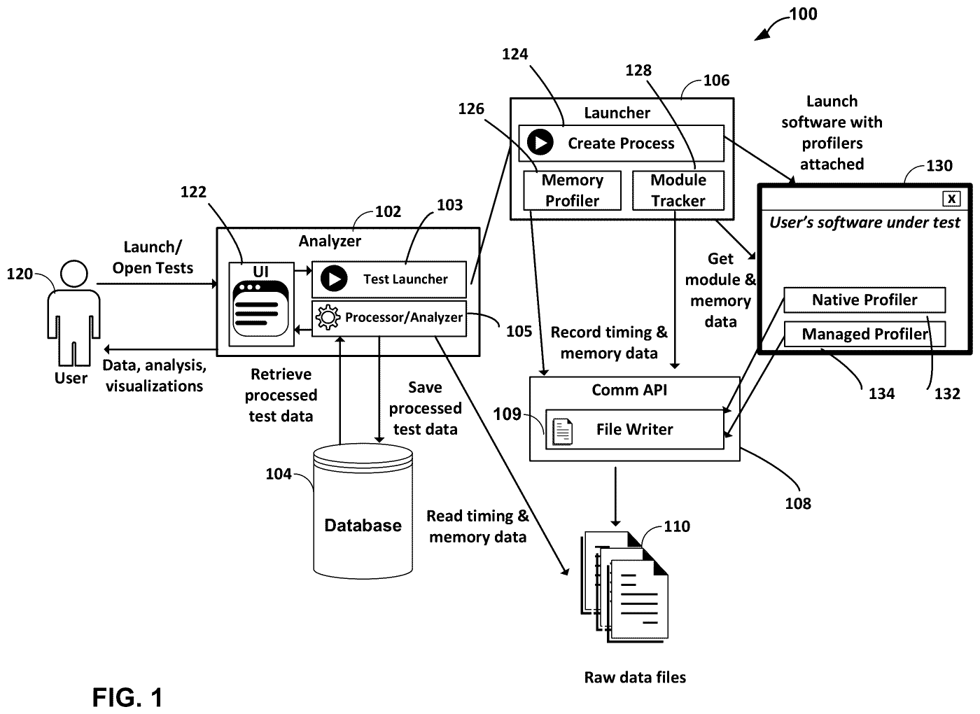

FIG. 1 is a block diagram illustrating an application performance and memory usage profiling system 100 (“profiling system 100”) analyzing an application under test (AUT 130), in accordance with the techniques of the disclosure. In one example approach, profiling system 100 profiles some or all parts of an application. For instance, in one such example approach, a software developer creates a test configuration in the profiler and configures a test by selecting to profile performance (e.g., processor utilization), memory, or both, as well as by selecting which code functions and/or methods to focus on when profiling the AUT. In general, the test configuration may be applied to one or aspects of the AUT, where the aspects may include a function, a set of functions, a method (which may include parts of one or more functions), or a set of methods. While the test is running, the user interacts with the application to invoke the aspects(s) of the AUT that were selected for targeted profiling. Alternatively, the profiler may be configured to automatically invoke the aspects(s) of the AUT being targeted. In some example approaches, the profiler includes automated performance testing that programmatically sets a method's input parameters, allowing for the collection of various data without user interaction.

In the example shown in FIG. 1, profiling system 100 includes an analyzer 102 connected to a database 104 and a launcher 106. In one such example approach, analyzer 102 reads timing and memory data from launcher 106 via a communications (comm) application programming interface (API) 108. In one example approach, the timing and memory data 110 is read from launcher 106 by file writer 109 and transferred by file writer 109 to analyzer 102 as raw data files 110.

In one example approach, analyzer 102 includes a processor/analyzer 105 used to request particular test information from communications API 108, to receive the requested test information from file writer 109, and to store the received test information to database 104. In addition, in some such example approaches, analyzer 102 retrieves test data from database 104 to transfer to a user 120. Furthermore, in some such example approaches, analyzer 102 retrieves test data from database 104 for further analysis (such as for generating visualizations) before transferring the data, analysis and visualizations to a user on a connected user machine 120. In one example approach, user machine 120 is connected to a graphical user interface (GUI) 122 within analyzer 102 that may be used to launch tests in launcher 106 and to open the results of such tests for further analysis.

In one example approach, user machine 120 provides users with control of the configuration of their profiling tests. In one such example approach, a user may choose, via the connected user interface 122, to profile function timing data, module timing data, memory data, or some combination of those options. This allows the user to not only investigate both performance and memory in the same test, if necessary, but also allows the user to limit profiling so that the analysis is faster, and the user is only presented with data that they care about.

In one example approach, targeted profiling allows users to select the methods within the AUT that will be profiled. When the test runs, profiling system 100 may record timing data for each of the selected methods as well as the methods called inside the selected methods. Targeted profiling allows for faster tests and less data to sift through when the test is completed, making it easier to identify performance and memory problems in the functions that the user is looking for. Profiling system 100 also allows the option to select all methods in a test to create a test similar to a traditional profiler. In one such example approach, profiling system 100 analyzes the data it collects from profiling runs and generates several visualizations and data representations to show the users mathematical and visual representations of the performance and memory consumption of their software test. The graphs of the data may be used by users to spot trends of performance and memory use, providing a mechanism for quickly find poorly-scaling or otherwise data dependent functions without requiring large amounts of data for the AUT to process.

In one example approach, profiling system 100 includes an automated profiling feature with a command line API. The automated profiling feature may be used to complete tests without the need for the user to manually interact with the AUT. In one such example approach, profiling system 100 includes a complexity timing analysis feature used to allow the user to evaluate the performance of targeted functions at small input sizes, and then predict that performance as the input size grows larger than the test data provided.

In one example approach, analyzer 102 includes a test launcher process 103 used to launch profiler tests. In some such example approaches, test launcher process 103 receives a profiling test from graphical user interface 122, transfers the test to launcher 106 and initiates the test at launcher 106. In one example approach, launcher 106 responds by creating a process for each test at create process 124. In one example approach, launcher 106 includes a memory profiler 126 and a module tracker 128. Memory profiler 126 operates with AUT 130 to profile memory usage while module tracker 128 performs timing analysis of methods and methods under methods in AUT 130. In one such example approach, profiling system 100 further includes a component-level profiler which tracks the lifetime of each module that was active in AUT 130 during a test run.

In one example approach, launcher 106 transfers launch software including a native profiler 132 and a managed profiler 134 to AUT 130. AUT 130 installs the native profiler 132 and the managed profiler 134 and launches the software for each test on AUT 130. In one example approach, native profiler 132 and managed profiler 134 are configured to save results from the profiling to a file writer 109 in communications API 108.

An advantage of profiling system 100 is that it quickly identifies performance-limiting functions and excessive memory use in a software application without requiring time-consuming recompilation or source-level access. With profiling system 100, a user may focus data collection of particular areas of the code by selecting files, classes, and/or methods to target during profiling. This method of targeted profiling reduces the amount of data gathered and displayed and further reduces profiling overhead, significantly saving time, and increasing reliability. The user is presented with the timing data to support decision making without being presented with unneeded data.

In one example approach, the memory profiler 126 of launcher 106 keeps track of the total number of bytes of memory used by the AUT 130. The memory profiler 126 may also identify which methods were active when memory usage spikes or dips occur. Profiling system 100 features easy user access to many tools for analyzing profiling data, ranging from mathematical analysis to visualizations and graphs for easy identification of performance problems. This intuitive interface minimizes the training needed for operators and software developers.

Profiling system 100 enables developers to identify performance and memory problems in software prior to deployment of the software, when it is easier and requires less resources to fix any problems that are found. Developers are able to adjust the configuration of their profiling tests to investigate the performance and memory of the AUT as narrowly or as broadly as they need. Profiling system 100, therefore, helps developers quickly identify poorly-scaling or otherwise data-dependent functions in a large code base. While existing profilers generally only show the user which functions are slow within a given performance run, profiling system 100 provides the option to run the same code over multiple dataset sizes and to instantly pinpoint functions that scale poorly based on the different inputs used over several runs. Profiling system 100 also predicts the performance of methods at larger input sizes than those tested, enabling the user to predict excessive lag or even crashes and fix them before deployment. These benefits apply to both DoD and commercial entities that develop software.

Profiling system 100 features several analysis tools for users to investigate the data retrieved from the profiling runs. For performance profiling runs, profiling system 100 offers features to view the time spent in each function as well as the execution path of the functions. Users can also view a graph of each call of a specific function within a run. For memory profiling runs, users can view the flat memory data as well as a graph displaying the data use across an entire run and within functions. Profiling system 100 also features several tools to compare performance and memory use between runs within the same test. By using the software, developers are able to create profiling tests to investigate memory and performance issues in their own applications in order to improve their code and prevent costly delays and crashes once the application is deployed.

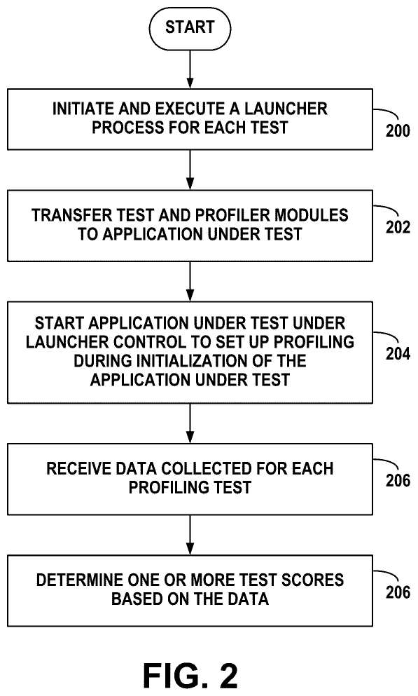

FIG. 2 is a flowchart showing a method of testing an application under test, in accordance with the techniques of the disclosure. When a profiler test is conducted, the test initialization process may include several steps. As shown in FIG. 2, profiling system 100 initializes and executes a Launcher process in launcher 106 (200). In general, profiling system 100 initiates a launcher for profiling one or more aspects of the AUT. The one or more aspects may include one or more of a function, a set of functions, a method, or a set of methods of the AUT. The Launcher process transfers one or more profiling tests and one or more profiler modules associated with the one or more profiling tests to AUT 130 (202). In one example, each profiling test may be associated with a process to be run on the AUT. The Launcher process then starts the AUT 130 under Launcher 106 control to set up native profiling during the initialization of the AUT 130 (204). The initialization may hook one or more of the profiler modules to the process (e.g., aspect) of the AUT under test. In some examples, profiling system 100 may start the profiling tests in a process that is already running.

Profiling system 100 may further receive data collected from each profiling test (206), and determine one or more test scores for the aspect of the AUT based on the data collected for each profiling test (208). In one example, profiling system 100 may run multiple profiling tests on the same aspect of the AUT, wherein the multiple profiling tests use different input parameters, and may receive respective data for each of the multiple profiling tests. In one example, to determine the one or more test scores, profiling system 100 is configured to compare memory utilization in the respective data for each of the multiple profiling tests to determine a memory utilization score. In another example, to determine the one or more test scores, profiling system 100 is configured to compare processor utilization in the respective data for each of the multiple profiling tests to determine a processor utilization score. In other examples, the one or more test scores include a computational complexity score. In some examples, the computational complexity score may be defined by a complexity timing equation, as will be discussed below. In a further example, profiling system 100 is configured to output a visualization of the one or more test scores.

In one example, the AUT runs within a Microsoft Windows 10 operating system. As is common in the Windows environment, when an application loads and initializes, there is a complicated sequence where many Windows shared library modules (also known as dynamic-link libraries or DLLs) are loaded into process memory. In one example approach, the DLLs are loaded into process memory with application-specific and/or third-party modules by a Windows DLL Loader (some are triggered by others in a nested chain that can vary in sequence).

One of the major changes introduced in Windows 10 concerns how DLLs are loaded into the process. The Windows 10 DLL loader was changed to be multi-threaded, where multiple threads work together to load and initialize the many DLLs in parallel. Most Windows processes have several dozen DLLs, most of which are built-in Windows DLLs. Some processes exceed 100 modules; such as with the DoD Joint Mission Planning System (JMPS). This creates a potential for race conditions for any interruption during the load process, especially if changes are made to the system DLLs.

In one example approach, native profiling includes an initialization process where the Launcher 106 creates an AUT process and loads the Native Profiling module 132 into this process very early in the AUT lifecycle. In one such example approach, profiling system 100 uses a Boothook method to accomplish this. The Boothook approach hooks a Windows API function (LdrLoadDll) that is called for every module load event. The hook modification performs a one-time action to call another Windows API function (LoadLibrary) and to trigger the loading of the profiling DLL (tcppprof.dll).

When this DLL initializes, it loads a lightweight data logging library that stores function timing data to file during the test, and then goes through a sequence to hook targeted native functions in already loaded modules and set an event handler to examine all future module load events to hook any targeted native functions that are present in those modules (during the lifecycle of the AUT test execution).

In another example approach, another method is used to inject the profiler into the AUT 130. This alternative approach to the original Boothook Injection method is called the Remote Thread Injection method. Rather than hooking the Win32 API, this approach creates a remote thread in the AUT process that then loads the profiling DLL “from the inside”. A similar method was also developed similar to the remote thread injection called Asynchronous Procedure Call injection (APC). Instead, if creating a new thread, APC injection uses an existing thread in the AUT 130 to do the hooking. The Remote Thread Injection approach overcame a problem 32 bit native test AUT example encountered on the early Win 10 LTSB configuration and seemed to work perfectly. Further testing with more complicated AUT 130 (e.g. JMPS version 1.5.305) showed the alternate approach needed refinement. When a larger set of targeted native functions (contained in native modules loaded later in the lifecycle) was chosen for the test, some of the native functions did not get properly hooked while others did, resulting in a subset of selected native functions for which profiling data did not get collected.

Experiments were conducted to identify or rule out any problems related to the two native profiling modules. The profiler DLL was replaced with a trivial DLL with minimal initialization burden. The initialization sequence was examined with different levels of data collection and debugging instrumentation. Experiments delaying the setting of the Boothook injection step were also conducted.

Both approaches for injecting the native profiler into 32-bit AUT processes are valid. They are similar with different pros and cons and may be optimally suited for different kinds of test configurations. The development of the thread injection method also lays the ground to support profiling an already running process since the Boothook method cannot be used in that scenario. In one JMPS example approach, a release of profiling system 100 uses the Boothook Injection method for 32-bit native functions inside AUT processes since the Windows 10 issue only manifests in old Windows 10 Long-term Servicing Branch (LTSB) versions and the JMPS developer community has moved to configurations of Windows 10 not affected by the issue.

In one example approach, profiling system 100 also support profiling of both 32-bit and 64-bit applications and libraries for Windows 10 operating systems. The first step in this task was to reorganize profiler components to ensure profiling system 100 includes x86 and x64 builds of profiler modules. In one example approach, the architecture of profiling system 100 included executables and libraries that interact with each other to perform the profiling and analysis features. In one such example approach, as a part of this task, profiler modules were built for both x86 and x64 but the analyzer software was intentionally organized to handle both 32-bit and 64-bit profiling in one single application.

To profile 64-bit applications, profiling system 100 hooks to the AUT 130 in a similar fashion to the 32-bit case. The Remote Thread Injection method is mostly platform neutral. It was adapted to inject the 64-bit versions of profiler DLLs. While the Remote Thread Injection works in most scenarios producing profiling data for the AUT, the main drawback of this method is that the hooking process might not happen early enough to profile the application DLLs. Since applications such as JMPS use DLLs for many of their functions a Boothook approach was developed for 64-bit.

The 64-bit Boothook method was developed using the same approach used with 32-bit Boothook; profiling system 100 hooks the Windows API LdrLoadDll function. Implementation-wise, the 64-bit Boothook (being a 64-bit binary code) is completely different from that of 32-bit Boothook and may require different handling and testing. Similar to what was seen with the Windows 10 Boothook issue in the case of 32-bit AUTs, the 64-bit Boothook is also affected by Windows DLL loader race conditions, except that in 64-bit case all versions of Windows 10 are affected and not just early Windows 10 versions. Delaying the hooking process until Windows DLLs are loaded, however, fixes the issue on 64-bit, although further testing may be required to determine when it is safe to do the hooking. In one example approach, therefore, profiling system 100 uses the Remote Thread Injection approach for profiling native code within 64 bit processes since that method is more robust in that configuration.

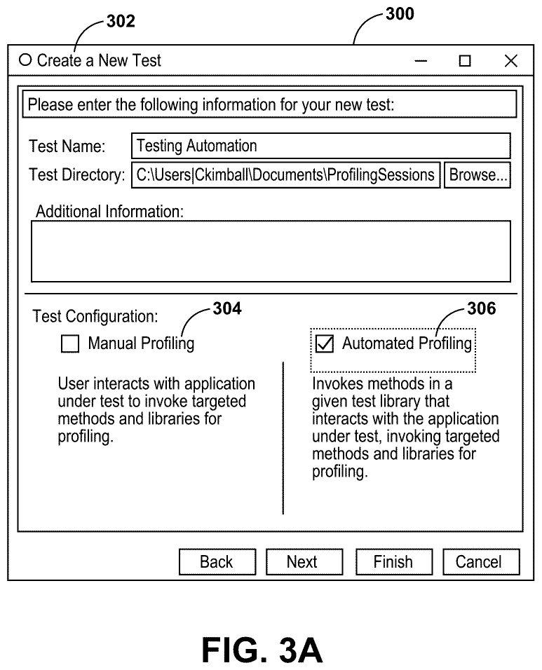

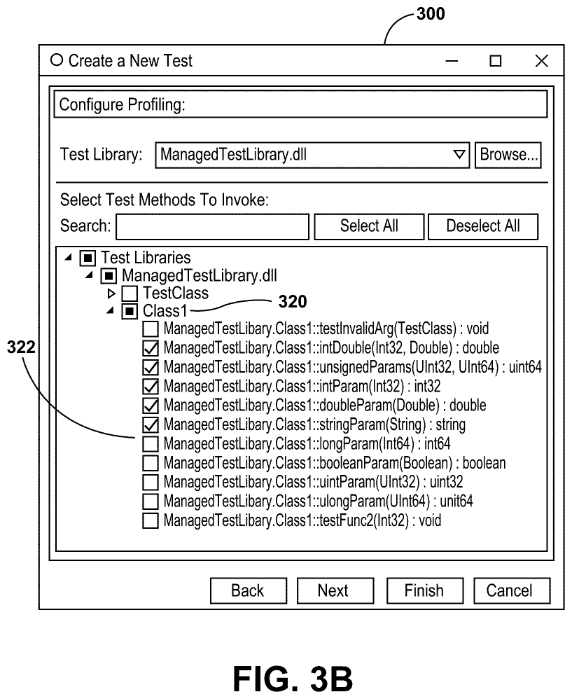

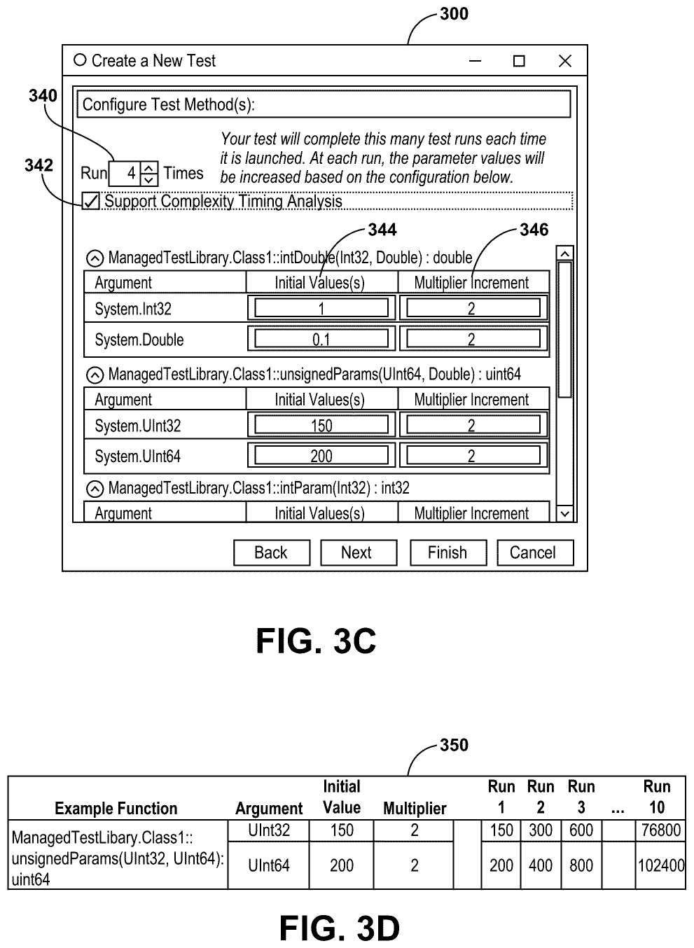

FIGS. 3A-3D illustrate automated profiling, in accordance with the techniques of the disclosure. In one example approach, profiling system 100 includes a unit-testing framework that supports automated profiling tests. In one such example framework, an automated test framework is configured such that a user may submit a test library to profiling system 100, select the test methods profiling system 100 should invoke, and define any argument values that the test methods require. In one example approach, the automated testing library allows the user to use a multiplier to change the input values at each run to see how change in input size affects performance.

In one example approach, profiling system 100 includes two components used to complete the automated profiling task: an automated test library invoker and a command line API. The automated test library invoker is used to automatically invoke methods inside a test library a user defines. In one example approach, the automated invoker supports .NET managed and native test libraries. Managed test libraries may be written in any .NET managed language, including C #, F #, and VB.NET. In one such example approach, each test method invoked by profiling system 100 must be public and may only contain parameters with types supported by profiling system 100.

For instance, a list of managed types supported might include:

| | | |
|---|---|---|
| Boolean | Byte | SByte |
| Int16 | UInt16 | Int32 |
| UInt32 | Int64 | UInt64 |
| IntPtr | UIntPtr | Char |
| Double | Single | |

with, in some example approaches, arguments that are arrays containing these types also supported by profiling system 100.

In one example approach, native test libraries are written in Visual C++. In one such example approach, each function invoked by profiling system 100 must be public, static, and exported from the DLL (using_declspec(dllexport) in the code). Additionally, all functions that the profiler invokes may only contain parameters with types that are supported. A list of native types supported may include:

| | | |
|---|---|---|
| bool | short | unsigned short |
| int | unsigned int | long |
| unsigned long | longlong | unsigned longlong |
| double | long double | float |
| char | | |

Arguments that are pointers of any of these types are also supported.

In one example approach, as is illustrated in FIG. 3A, GUI 122 creates a display 300 for UI 120 that includes test creation dialog 302 used to help users create automated test configurations. In one example approach, when the user creates a test, they choose whether they want to create a manual test 304, where the AUT runs and the user must ensure that targeted methods are invoked, or an automated test 306, where profiling system 100 invokes a given test library that interacts with the AUT 130.

After selecting to create an automated test as shown in FIG. 3A, the user then configures that test by selecting the test libraries and methods to be invoked, as shown in FIG. 3B. In one example approach, once a user identifies a test library 320, profiling system 100 generates a list 322 including all public test methods inside that test library. In one such example approach, any test methods that cannot be invoked by profiling system 100 including, for example, methods that take in an argument of a type that profiling system 100 does not support, are disabled so the user may not select them. The user may check the box next to any methods that they want to invoke during this automated test session.

In one example approach, as shown in FIG. 3C, the next step provides the user with the opportunity to configure the automated test even more. First, the user may select, at box 340, the number of times in a row to run the automated test. If the user wants to configure the test for complexity timing profiling analysis, they may check the corresponding box 342 and profiling system 100 gears their test creation to support such analysis.

The user may also configure the initial value 344 and the increment multiplier 346 to be applied each time the test is run. Each test function selected from the tree is listed, along with each argument that each test function takes in. For each argument listed, the user may edit the Initial Value field 344 to change what the value of this argument will be in the first run of each run set. The user may also edit the Multiplier Increment field 346 to change the factor by which the initial value is multiplied at each subsequent run in the run set.

After the user configures the automated test, in one example approach, the user configures the profiling targets similarly to how they would configure a manual test. The automated invoking component takes in the configuration that the user set during test creation. When the test is run, the automated invoker invokes each selected test method using the parameter values defined by the user. For each successive run, those values are increased based on the multiplier 346 the user selected during the test configuration. An example test sequence 350 is shown in FIG. 3D. Automated tests may be run inside GUI 122 or in a Command Line API, as discussed below.

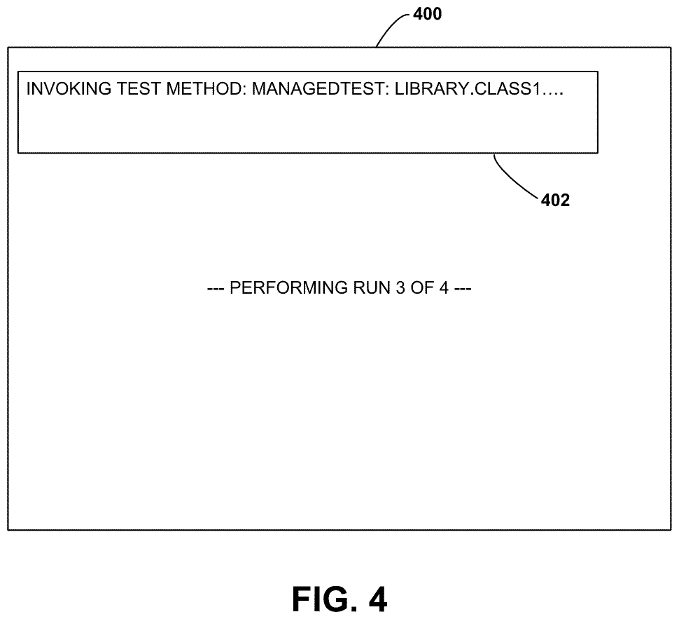

FIG. 4 illustrates an example profiler command line 402, in accordance with the techniques of the disclosure. A command line API is a useful feature for an automated profiling tool. In the example shown in FIG. 4, GUI 122 creates a display 400 with a command line 402 superimposed on display 400. By enabling test runs on the command line 402, users may include tests via profiling system 100 in their testing pipeline. Furthermore, routine test scripts may be entered and run on profiling system 100 without any further interaction from the user. In one example approach, a command line API executes profiling tests within profiling system 100 without interacting with GUI 122. In some example approaches, tests that are configured in the UI 120 via GUI 122 may also be run from the command line 402. This feature may be available for both manual and automated tests, although, in some example approaches, manual tests require the user to invoke targeted methods.

Once the test runs complete, the run data is automatically processed and saved to database 110. In one example approach, the newly generated runs for a test become available to view in each relevant analysis tool or visualization feature of profiling system 100 the next time the user views that test in GUI 122.

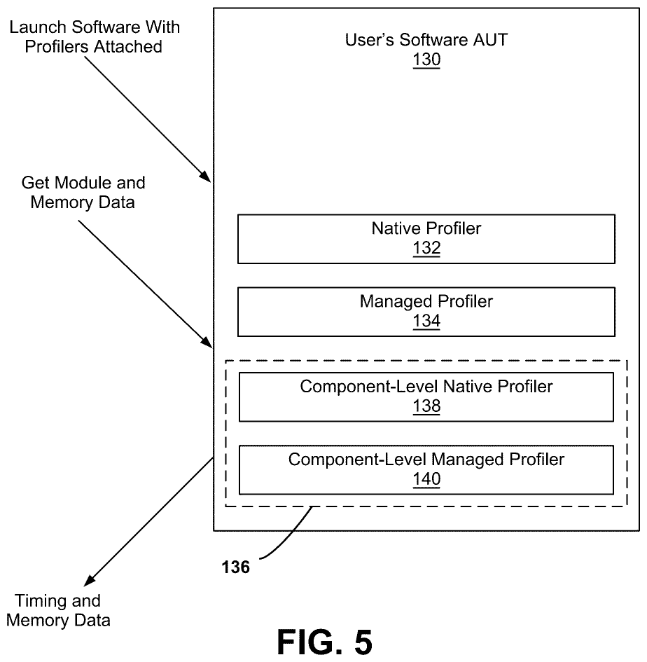

FIG. 5 illustrates component level profiling, in accordance with the techniques of the disclosure. In one example approach, profiling system 100 includes a sampling profiler that keeps track of each active module while the AUT 130 is running and that the records the timing data. When the user creates a test, they may select to profile active module timings as well as function timing and memory data. If active module profiling is selected for a test that is launched, profiling system 100 attaches a component-level profiler 136 to the AUT 130 along with any other profilers the user specified (such as the native profiler 132 and the managed profiler 134 shown in FIG. 5). In one example approach, profiling system 100 includes two component-level profilers, one for recording native modules (component-level native profiler 138) and one for managed modules (component-level managed profiler 140). In one such example approach, native component-level profiler 138 uses a sampling profiling approach to regularly check the stack of native modules 132 that have been loaded by the AUT. When a module shows up on the stack, component-level native profiler 138 records a module enter. As the stack changes and modules are removed from the stack, the component-level native profiler 138 records a module leave. Leaves and enters are recorded along with timing data in the raw data files associated with the run.

Component-level managed profiler 140 uses a similar profiling technique to managed profiler 134. In one example approach, component-level managed profiler 140 uses an ICorProfilerCallback2 Interface, available through Microsoft. This interface provides methods used by the Common Language Runtime (CLR) to notify profiling system 100 when a module is loaded or unloaded. Component-level managed profiler 140 receives the notifications and records the timestamps of when a module is entered and exited.

In one example approach, profiling system 100 includes visualization and analysis tools that allow users to view the results of test data. The visualization tools include a cumulative module timing data grid that lists each module that was active during a particular run and calculates how much time was spent in each module, a cumulative module timing data grid that lists each module that was active during a particular run and calculates how much time was spent in each module, a graph of active modules that visually displays the lifetime of each module in the AUT 130, and also shows the order in which the libraries were loaded.

In one example approach, the visualization tools include memory usage graphs and table tools to give the user the option to show or hide modules in the view. When the user selects to show a specific module on the memory graph, a section of the graph is highlighted that represents the lifetime of the module. Using this tool, users may see how memory usage changed while the module was active. Such a tool may also be used to show if a spike or dip in memory use occurred while a selected module was loaded. In one such example approach, the color of the highlighted area is selected to correspond to the color of the checkbox when it is checked.

In one example approach, checking a function or module while viewing the table of memory data colors the rows of data that were collected while that function or module was active. Unchecking these items removes the coloring associated with that module or function.

In one example approach, profiling system 100 includes a summary graph feature, which summarizes the memory usage and/or worst performing function timings across all runs in a test. In one such example approach, the summary graph further includes an option for viewing a summary of the modules that were used the most across all runs.

In one example approach, the tools include comparison tools, including a tool that performs a comparison of cumulative module timings. This tool compares the time each module was active in each run to the average time across all runs. In one such example approach, the comparison tool may be within tests; a similar feature allows the user to perform this analysis between two tests as well.

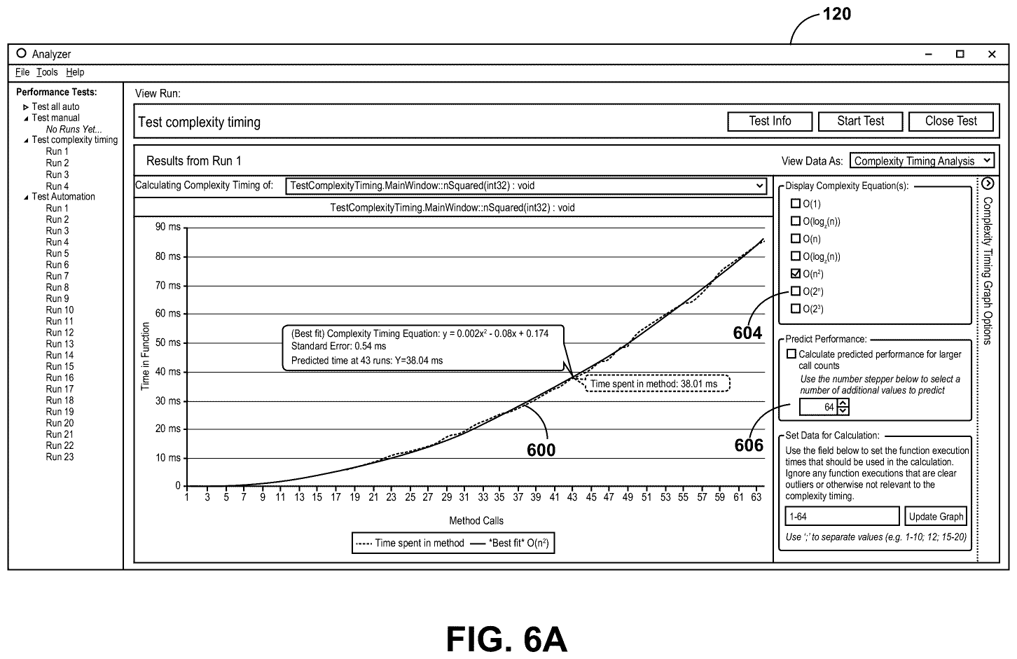

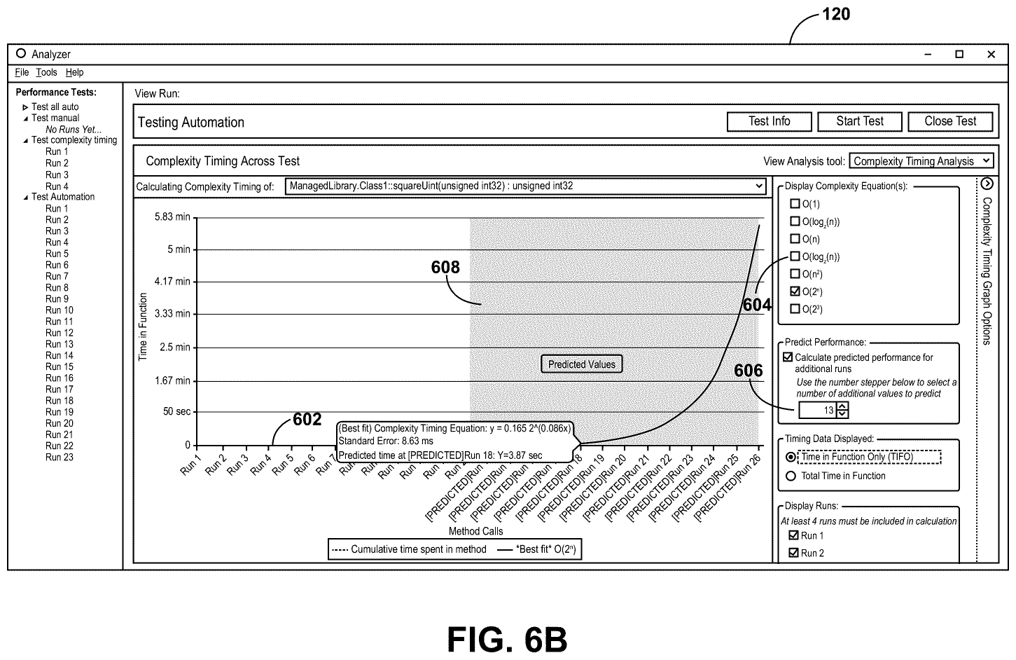

FIGS. 6A and 6B illustrate complexity timing analysis, in accordance with aspects of the present disclosure. In one example approach, a tool matches a set of function timing data points to a complexity timing equation. Graph and analysis tools may then be used so the user may learn more about the complexity timing of their functions and may predict function performance at higher values of x. In one such example matching tool approach, regression and curve fitting algorithms were applied to match a set of function timing values to a complexity timing equation. In one example approach, the matching tool calculates the closest matching equation for each of the following complexity timing equations: O(1), O(log₂(n)), O(n), O(n*log₂(n)), O(n²), O(2ⁿ), O(n³). Constraints were added to the matching tool to make sure that matched equations actually represented positive growth. For example, the matching tool doesn't allow a negative or near-zero coefficient for a linear equation, as that would represent negative growth or no growth (i.e., a constant value). After all best-fit equations are calculated, profiling system 100 calculates the distance between each equation and the actual data points. The equation with the smallest distance is identified as the best-fit equation for the set of function timings.

In one example approach, two complexity timing analysis features were added to UI 120. The first (shown in FIG. 6A) calculates the complexity timing 600 where n is the number of executions of the function in a particular run. The other feature (shown in FIG. 6B) calculates complexity timing 602 where n is the time spent in the function at each run across an entire test. By using either of these tools, the user can view the complexity timing graph of targeted functions.

In one example approach, profiling system 100 automatically calculates and plots the “best fit” equation. As shown in FIG. 6A, in one such example approach, users may choose to narrow down the x-values used to generate the best fit equation. For example, if there are a few outliers that may be skewing the best fit equation, the user may set the data to use in the calculation to avoid these values. In some example approaches, however, as shown in FIGS. 6A and 6B, the user may decide to show other close matches; they may do so by selecting other equations in options panel 604.

In one example approach, as shown in FIG. 6B, UI 120 includes a performance prediction feature inside the complexity timing analysis tool. Users may use this feature to predict if a function's performance will become untenable at larger input sizes or at a larger number of executions. In one such example approach, a user invokes the performance prediction feature by checking a box in “Predict Performance” section 606 and selecting the number of additional values to predict. In one example approach, the performance prediction feature highlights values, within zone 608, computed for the predicted values so they are easy to distinguish from the actual known values.

In one example approach, profiling system 100 supports profiling of a running process. This feature enables users to attach profiling system 100 to a live process to collect performance data. This enables profiling system 100 to support new use cases. For example, if a user is running their software and encounters a problem, it may be difficult to launch the program again inside of profiling system 100 and recreate the conditions that caused the problem. With this feature, profiling system 100 attaches its profilers to the running process and immediately starts profiling. In one example approach, analyzer 102 supports profiling of native processes and libraries in running processes. In one such example approach, analyzer 102 implements profiling functionality for running processes, including profiling of native processes and libraries in running processes and profiling of managed binaries.

In one example approach, profiling system 100 gathers timing data for native processes and libraries loaded in a live process. It also supports profiling of native modules loaded in AUT 130, as well as overall memory usage. In one such example approach, profiling system 100 uses a DLL injection method other than those described above. Instead of injecting the profiler DLL immediately after launching, the DLL is injected as soon as profiling system 100 receives a valid handle. DLL injection is actually more successful in this case because profiling system 100 does not have to wait for the process to load all DLL before injecting.

In one such example approach, the profiler launch process is reorganized so it does not rely on sharing an environment with AUT 130. Attaching is supported in the backend, and user-friendly paths for attaching a profiling test to a running process were implemented in UI 120. In one example approach, this included support for attaching both in the Analyzer GUI and in the command line API.

In one example approach, two user workflows are supported. In the first case, a user launches a profiling test that targets an application that is already running on the user's system. In that workflow, first, profiling system 100 lets the user know that the process is already running. Then profiling system 100 asks the user if they would like to attach to a running instance or launch a new instance for profiling. If the user wants to launch a new instance, profiling system 100 proceeds as normal with our previous profiling method of launching the AUT with profiler 132 or 134 already attached. Otherwise, the profiler is attached to an already running instance. If there are multiple instances of the AUT 130 running on the user's computer, profiling system 100 asks the user to select the process to target.

Once the user chooses a running process to profile, launcher 106 launches a profiler (e.g., profiler 132 or 134) and uses DLL injection to attach it to the running instance the user has targeted. This user workflow is supported in Analyzer GUI 122 and in the Command Line API.

In a second user workflow, running processes are identified and listed by analyzer 102. The user selects a process to attach and then profiling system 100 targets the selected process with either an existing test or a new profiling test. If the selected process already has one or more tests that target the executable, the user may select a test to use to profile the selected process. If there are no tests matching that executable, or if the user decides that none of those tests should be used in this case, the user may select to create a new test. This will open another dialog window that walks the user through creating a test and selecting targets in the test to profile.

In one example approach, a Microsoft Profiling API was used as the managed profiler. In a second example approach, the compiled Microsoft Intermediate Language (MSIL) of managed binaries was hooked for profiling. Profiling system 100 uses the hooks in the second approach to record performance data, similarly to the native profiler described above. The second approach allows profiling system 100 to remove references to the deprecated profiling API, and improves the overhead the managed profiler adds to the AUT.

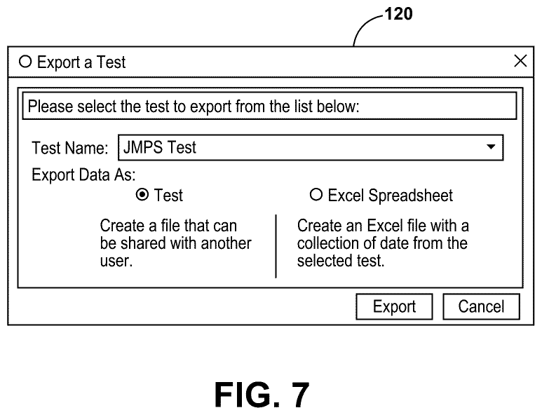

FIG. 7 illustrates methods for sharing tests within profiling system 100, in accordance with aspects of the disclosure. In one example approach, analyzer 102 allows users to share tests and test data and includes exporting and importing capabilities. Users may export complete profiler tests into compressed files, which may be imported into another user's Analyzer software. Imported tests may be viewed in the UI 120, including all data visualization and analysis tools. This feature allows for collaborative profiling so team members can share their findings with each other easily. Additionally, analyzer 102 enables users to export test data as Excel spreadsheets. The spreadsheets include data visualizations and analysis similar to those found in the Analyzer GUI 122. This allows users to auto-generate reports that can be shared with anyone and enables stakeholders who have an interest in the performance of the software under test to view performance statistics and follow along with optimization efforts, without requiring the use of the Analyzer software to view the data.

In one example approach, test data is compressed into a shareable file. In one such example approach, the compressed file includes the test directory, configuration files, all run data, and the SQLite database for that test. Compressed test files are then encrypted to ensure that sensitive data is protected when test files are shared. In one example approach, a window in GUI 122 is included to handle exporting a test as a complete test or as an excel spreadsheet. An exporting option is also incorporated into the command line API.

In one example approach, GUI 122 includes an option to import compressed test files into the Analyzer 102. In one such example approach, analyzer 102 includes a validation tool to ensure that the imported file is valid, complete, and not corrupted. The validation tool decrypts and decompresses the file. It also checks the contents of the decompressed test directory to ensure that all required files are present and valid. After validating the test directory and files, the imported test is added to the active tests in Analyzer 102. UI 120 is then updated to display the newly imported test.

As shown in FIG. 7, in one example approach, GUI 122 includes an option to export test data to an Excel spreadsheet to enable users to keep and share records of test data. The exported spreadsheet includes several different worksheets containing data from the test runs. Each sheet in the spreadsheet contains data grids and visualizations of the performance data collected in the exported test. The data in the exported spreadsheet resembles data visualizations and tools present in Analyzer 102. In one example approach, the exported spreadsheets include a Summary Graph and a Cumulative Run Comparison. Summary Graph displays a summary of the profiling results including function timings, memory usage, and active modules, depending on how the user configured their profiling test. Cumulative Run Comparison displays a data grid of each function's performance at each run and the distance from the average performance across all runs. Both of these data visualizations are available in GUI 122 as well. Other sheets with relevant data are in the spreadsheet include Test Information, Cumulative Timings, Memory Usage, and Module Timings.

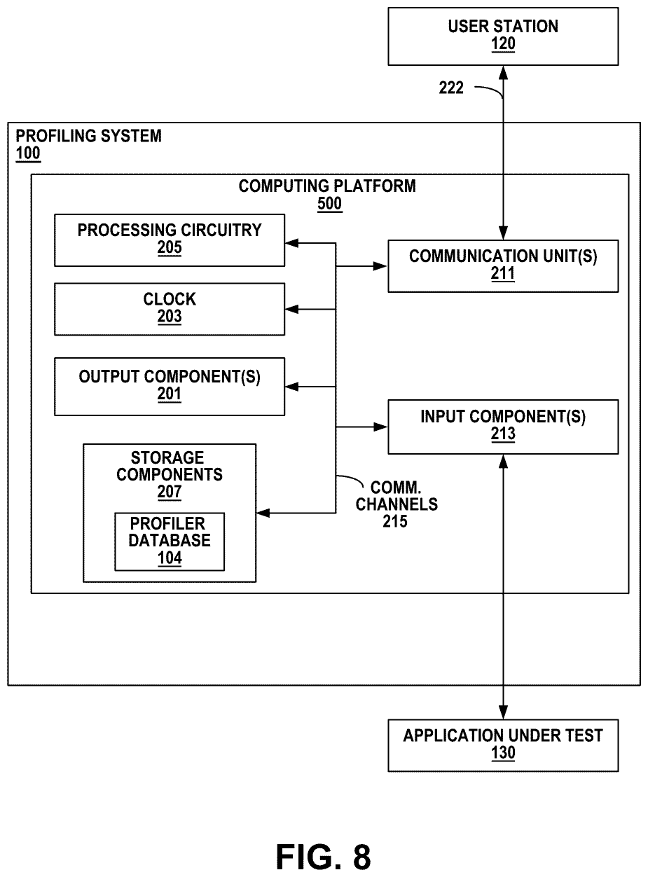

FIG. 8 illustrates a profiler system installed on a computing platform, in accordance with the techniques of the disclosure. In the example shown in FIG. 8, sensing platform 120 (e.g., an MMS satellite) includes a computing platform 500 connected via a network to ground station 114 and via a communications channel to satellite sensors 214.

As shown in the example of FIG. 5, computing platform 500 includes processing circuitry 205, one or more input components 213, one or more communication units 211, one or more output components 201, and one or more storage components 207. Communication channels 215 may interconnect each of the components 201, 203, 205, 207, 211, and 213 for inter-component communications (physically, communicatively, and/or operatively). In some examples, communication channels 215 may include a system bus, a network connection, an inter-process communication data structure, or any other method for communicating data.

In one example approach, processing circuitry 205 includes computing components of, for instance, analyzer 102 or launcher 106. One or more communication units 211 of computing platform 500 may communicate with external devices, such as user station 120, via one or more wired and/or wireless networks 222 by transmitting and/or receiving network signals on the one or more networks. Examples of communication units 211 include a network interface card (e.g., such as an Ethernet card), an optical transceiver, a radio frequency transceiver, a GPS receiver, or any other type of device that can send and/or receive information. Other examples of communication units 211 may include short wave radios, cellular data radios, wireless network radios, as well as universal serial bus (USB) controllers.

One or more input components 213 of computing platform 500 may receive test and memory data from AUT 130. One or more output components 201 of computing platform 500 may generate output and transmit the output to other systems.

Processing circuitry 205 may implement functionality and/or execute instructions associated with profiling system 100. Examples of processing circuitry 205 include application processors, display controllers, auxiliary processors, one or more sensor hubs, and any other hardware configure to function as a processor, a processing unit, or a processing device. Processing circuitry 205 may retrieve and execute instructions stored by storage components 207 that cause processing circuitry 205 to perform operations for profiling processes executing on AUT 130. The instructions, when executed by processing circuitry 205, may cause profiling system 100 to store information within storage components 207. In one example, storage components 207 include profiler database 104.

One or more storage components 207 may store information for processing by computing platform 500 during operation of system 100. In some examples, storage component 207 includes a temporary memory, meaning that a primary purpose of one example storage component 207 is not long-term storage. Storage components 207 on computing platform 500 may be configured for short-term storage of information in volatile memory and therefore not retain stored contents if powered off. Examples of volatile memories include random-access memories (RAM), dynamic random-access memories (DRAM), static random-access memories (SRAM), and other forms of volatile memories known in the art.

Storage components 207, in some examples, also include one or more computer-readable storage media. Storage components 207 in some examples include one or more non-transitory computer-readable storage mediums. Storage components 207 may be configured to store larger amounts of information than typically stored by volatile memory. Storage components 207 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 207 may store program instructions and/or information (e.g., data) associated with event modeling and detection. Storage components 207 may include a memory configured to store data or other information associated with event modeling and detection.

Clock 203 is a device that allows computing platform 500 to measure the passage of time (e.g., track system time). Clock 203 typically operates at a set frequency and measures a number of ticks that have transpired since some arbitrary starting date. Clock 203 may be implemented in hardware or software.

The profiler described herein is a complete automated performance and memory profiler that may be used in the software development process to quickly identify performance and resource bottlenecks in software. Using this system, developers may adjust the configuration of their profiling tests to investigate the performance and memory of the AUT 130 as narrowly or as broadly as they need to. Profiling system 100 helps developers quickly identify poorly-scaling or otherwise data-dependent functions in a large code base. Profiling system 100 also provides the option to run the same code over multiple dataset sizes and to instantly pinpoint functions that scale poorly based on the different inputs used over several runs. Finally, profiling system 100 predicts the performance of methods at larger input sizes than those tested, enabling the user to predict excessive lag or even crashes and fix them before deployment. These benefits apply to both DoD and commercial entities that develop software.

Profiling system 100 improves the software development process by providing an intuitive tool that can analyze .NET managed and native code performance and memory, all within the same test. The system enables users to have complete control of their profiling tests so that they can specify which types of profiling to record and which parts of the AUT 130 to target during profiling.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A profiling system, comprising:
a memory, the memory storing instructions for profiling an application under test (AUT);
one or more processors communicatively coupled to the memory, the processors configured to execute the instructions, the instructions when executed causing the one or more processors to:
initiate, within the one or more processors, a launcher for profiling an aspect of the AUT;
transfer, to the AUT, one or more profiling tests and one or more profiler modules associated with the one or more profiling tests;
start the one or more profiling tests in the AUT under launcher control, including setting up profiling during initialization of a process in the AUT;
receive, at the profiling system, data collected for each profiling test; and
determine one or more test scores for the aspect of the AUT based on the data collected for each profiling test.

2. The profiling system of claim 1, wherein the instructions when executed further cause the one or more processors to:
start the one or more profiling tests in a process that is already running.

3. The profiling system of claim 1, wherein the instructions when executed further cause the one or more processors to:
run multiple profiling tests on the same aspect of the AUT, wherein the multiple profiling tests use different input parameters; and
receive respective data for each of the multiple profiling tests.

4. The profiling system of claim 3, wherein to determine the one or more test scores, the instructions when executed further cause the one or more processors to:
compare memory utilization in the respective data for each of the multiple profiling tests to determine a memory utilization score.

5. The profiling system of claim 3, wherein to determine the one or more test scores, the instructions when executed further cause the one or more processors to:
compare processor utilization in the respective data for each of the multiple profiling tests to determine a processor utilization score.

6. The profiling system of claim 1, wherein the one or more test scores include a computational complexity score.

7. The profiling system of claim 6, wherein the computational complexity score is a complexity timing equation.

8. The profiling system of claim 1, wherein the aspect of the AUT is one or more of a function, a set of functions, a method, or a set of methods of the AUT.

9. The profiling system of claim 1, wherein the instructions when executed further cause the one or more processors to:
output a visualization of the one or more test scores.

10. A method, comprising:
initiating, within one or more processors of a profiling system, a launcher for profiling an aspect of an application under test (AUT);
transferring, to the AUT, one or more profiling tests and one or more profiler modules associated with the one or more profiling tests;
starting the one or more profiling tests in the process under launcher control, including setting up profiling during initialization of a process in the AUT;
receiving data at the profiling system that was collected for each profiling test; and
determining one or more test scores for the aspect of the AUT based on the data collected for each profiling test.

11. The method of claim 10, wherein starting the one or more profiling tests further includes starting the one or more profiling tests in a process that is already running.

12. The method of claim 10, further comprising:
running multiple profiling tests on the same aspect of the AUT, wherein the multiple profiling tests use different input parameters; and
receiving respective data for each of the multiple profiling tests.

13. The method of claim 12, wherein determining the one or more test scores comprises:
comparing memory utilization in the respective data for each of the multiple profiling tests to determine a memory utilization score.

14. The method of claim 12, wherein determining the one or more test scores comprises:
comparing processor utilization in the respective data for each of the multiple profiling tests to determine a processor utilization score.

15. The method of claim 10, wherein the one or more test scores include a computational complexity score.

16. The method of claim 15, wherein the computational complexity score is a complexity timing equation.

17. The method of claim 10, wherein the aspect of the AUT is one or more of a function, a set of functions, a method, or a set of methods of the AUT.

18. The method of claim 10, further comprising:
outputting a visualization of the one or more test scores.

19. A non-transitory computer-readable storage medium storing instructions that, when executed, cause one or more processors of a profiling system to:
initiate, within the ono or more processors, a launcher for profiling an aspect of the AUT;
transfer, to the AUT, one or more profiling tests and one or more profiler modules associated with the one or more profiling tests;
start the one or more profiling tests in the AUT under launcher control, including setting up profiling during initialization of a process in the AUT;
receive data from the AUT collected for each profiling test; and
determine one or more test scores for the aspect of the AUT based on the data collected for each profiling test.

20. The non-transitory computer-readable storage medium of claim 19, wherein the instructions when executed further cause the one or more processors to:
output a visualization of the one or more test scores.
